(19) United States
(12) Patent Application Publication
(10) Pub. No.: US 2009/0158080 A1
(43) Pub. Date: Jun. 18, 2009

(54) STORAGE DEVICE AND DATA BACKUP METHOD

(75) Inventors: Masanori Furuya, Kawasaki (JP); Koji Uchida, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/329,072

(22) Filed: Dec. 5, 2008

(30) Foreign Application Priority Data
Dec. 14, 2007 (JP) 2007-322840

(51) Int. Cl. G06F 12/16; G06F 11/07

(52) U.S. Cl. 714/2; 711/162; 711/E12.103; 714/E11.023

(57) ABSTRACT

A storage device includes: a storage unit for storing data; a memory for storing management information; a local storage unit for storing differential data; a controller for controlling the storage device in accordance with a process comprising the steps of: updating data; updating management information; transmitting differential data to the another storage device, the differential data being the updated portions of the data which have been updated after preceding backing up of data until current backing up of data; resetting the management information after transmitting the differential data; storing, when the storage device fails transmission of the differential data to the another storage device, the differential data and the associated management information in the local storage unit; and transmitting the differential data to the another storage device at a later time after resetting of the management information.

### CROSS-REFERENCE TO RELATED APPLICATION

This application is based upon and claims the benefit of priority of the prior Japanese Patent Application No. 2007-322840, filed on Dec. 14, 2007, the entire contents of which are incorporated herein by reference.

### FIELD

A certain aspect of the embodiments discussed herein is related to a storage device for backing up update data.

### BACKGROUND

As a method for efficiently creating backups of data at a plurality of points in time in the past, there is a generation backup system that backs up update data alone.

As shown in FIG. 15, there is a scheme wherein mirroring of an extent 1501 (extent of copying) from a main site 1501 to a remote site 1502 is performed by REC (remote equivalent copy; a technique which is mainly used to create a mirror 1504, 1505, and 1506 and in which storage data in a copy destination is synchronized with storage data in a copy source during a designated time period and at a designated data capacity), and wherein backup is created by fixing an data image at a point in time. In this scheme, disk capacity required for the remote site is (copy source size)×(number of generations).

As a conventional art associated with the present invention, for example, Japanese Laid-Open Patent Application Publication No. 2006-072635 discloses a data processing system and its copy processing method providing a copy processing technique for data processing system that allows concurrently realizing long distance copy and preventing data loss in the event of a disaster. Furthermore, for example, Japanese Laid-Open Patent Application Publication No. 2007-087036 discloses a snapshot maintaining device and method for maintaining and acquiring snapshot with high reliability.

However, generally, it is not often that updating is performed with respect to an entire area of an extent within which backing-up is to be performed. In many case, only a portion within the extent is changed. It is inefficient that, in order to collect backups of a plurality of generations, commensurable disk capacity must be prepared as in the conventional art. In recent years, with an increase in disk capacity being used, backup disks therefor are undesirably increasing. Furthermore, when performing remote transfer, an increase in transfer amount also creates a problem.

Moreover, if backups are being made in the same casing as that is being used in operation, it would take long time for recovery work in the event that a disaster or the like occurs, and further, it could become impossible to recover data.

### SUMMARY

According to an aspect of an embodiment, a storage device includes: a storage unit for storing data; a memory for storing management information; a local storage unit for storing differential data; a controller for controlling the storage device in accordance with a process comprising the steps of: updating data; updating management information; transmitting differential data to the another storage device, the differential data being the updated portions of the data which have been updated after preceding backing up of data until current backing up of data; resetting the management information after transmitting the differential data; storing, when the storage device fails transmission of the differential data to the another storage device, the differential data and the associated management information in the local storage unit; and transmitting the differential data to the another storage device at a later time after resetting of the management information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram of a configuration of a storage system according to an embodiment of the present invention;

FIG. 2 is a functional block diagram of the storage system according to the present embodiment;

FIG. 3 is a diagram of backup processing of the storage system according to the present embodiment;

FIG. 4 is a diagram of backup processing (generation switching) of the storage system according to the present embodiment;

FIG. 5 is a diagram of backup processing (data merging) in the storage system according to the present embodiment;

FIGS. 6A and 6B are diagrams of backup processing (processing during Halt) in the storage system according to the present embodiment;

FIGS. 7A and 7B are diagrams of backup processing (processing when path is opened) in the storage system according to the present embodiment;

FIG. 8 is a diagram showing an example of volume configurations in the storage system according to the present embodiment;

FIG. 9 is a table showing statuses of sessions in the storage system according to the present embodiment;

FIG. 10 is a diagram showing status transitions in the storage system according to the present embodiment;

FIG. 11 is a flowchart showing processing during Halt detection in the storage system according to the present embodiment;

FIG. 12 is a flowchart showing processing when path is opened after Halt detection in the storage system according to the present embodiment;

FIG. 13 is a flowchart showing processing of REC by a crawling engine in the storage system according to the present embodiment;

FIG. 14 is a flowchart showing REC processing with respect to a volume A due to an update occurrence, in the storage system according to the present embodiment; and

FIG. 15 is a diagram of conventional backup processing with respect to a remote site.

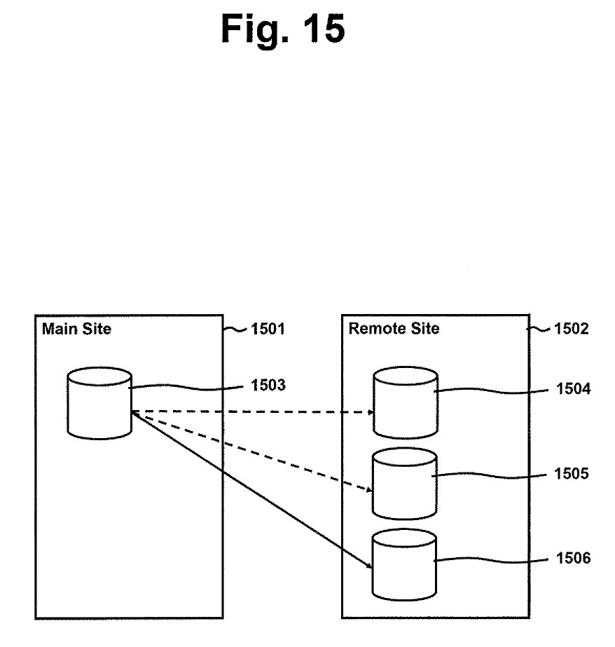

### DESCRIPTION OF EMBODIMENTS

Hereinafter, an embodiment will be described with reference to the appended drawings.

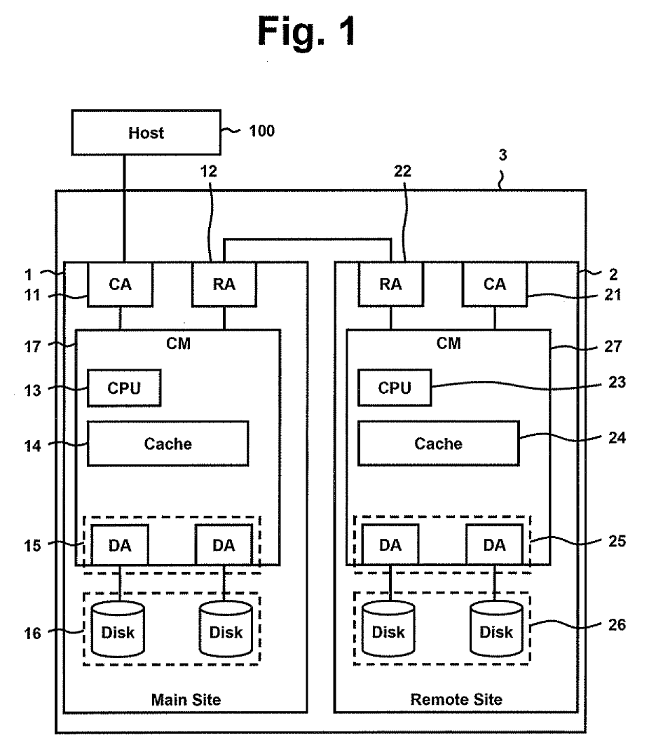

First, a configuration of the storage system according to the present embodiment is explained with reference to FIG. 1. The storage system 3 includes a MainSite 1 (first storage device), which is a copy source casing for operation data (data that user is using in operation), and a RemoteSite 2 (second storage device), which is installed at a remote site and which is a backup destination casing for the operation data.

The MainSite 1 includes a CA (channel adapter) 11, a RA (remote adapter) 12, a CM (centralized module) 171 and Disks 16. The CM 17 further includes a CPU (central processing unit) 13, a Cache 14, and DAs (disk adapters) 15.

The CA 11 controls an I/F (interface) with a Host 100, and the RA 12 controls an I/F between the MainSite 1 and the RemoteSite 2.

The CPU 13 is a module executing various calculation processing. The Cache 14 is a memory storing firmware or control data. An exclusive buffer for recording (i.e., bit buffer) is stored in this region.

The DAs 15 control I/Fs with the Disks 16, which are user disks storing at least operation data.

Likewise, the RemoteSite 2 includes a CA 21, a RA 22, a CM 27, and Disks 26 (which include a CPU 23, a Cache 24, and DAs 25. The CM 27 includes a CPU 23, a Cache 24, and DAs 25. Because each module included in the RemoteSite 2 has an equal function to that of a respective one of the MainSite 1, description thereof is herein omitted.

The storage system 3 is configured to be connected to Host 100 serving as a terminal for a user to use the storage system 3, via the CA 11.

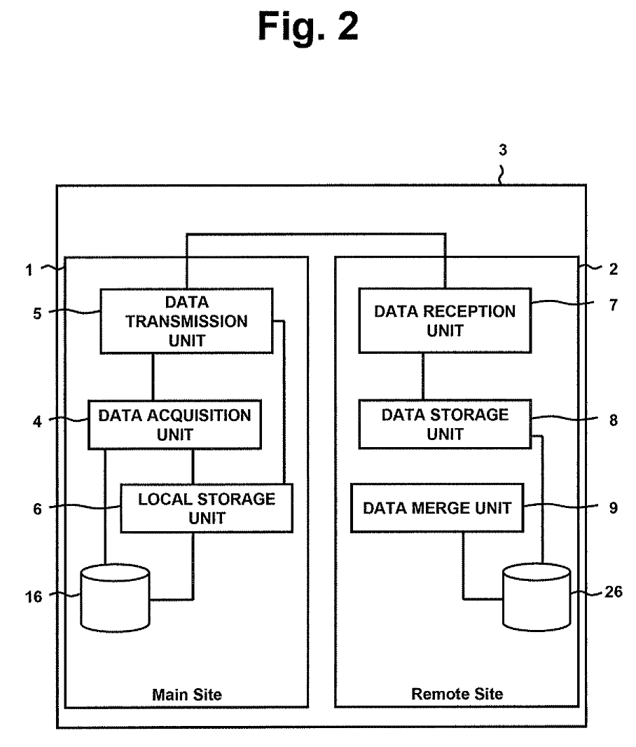

Next, functions of each of the MainSite I and the RemoteSite 2 are described with reference to functional blocks shown in FIG. 2. Here, it is assumed that the CM 17 performs functions of the MainSite 1 on the basis of command instructions and data transfers or the like from the CA 11, the RA 12, and the Disks 16. The CM 17 further performs various functions by causing the CPU 13 to process the firmware stored in the Cache 14. Similarly, the CM 27 performs various functions of the RemoteSite 2.

The MainSite 1 includes a data acquisition unit 4, a data transmission unit 5, and a local storage unit 6, while the RemoteSite 2 includes a data reception unit 7, a data storage unit 8, and a data merge unit 9.

With respect to the operation data stored in the Disk 16, the data acquisition unit 4 acquires differential data from a predetermined point in time which is a point in time when all data within a designatable extent out of the operation data has been stored in the Disk 26 of the RemoteSite 2, or a point in time when a generation has been switched by the data storage unit 8 or by the local storage unit 6. The data acquisition unit 4 also acquires all data within the designatable extent out of the operation data stored in the Disk 16. Hereinafter, all data within the designatable extent is referred to as “total data” as needed.

The data transmission unit 5 transmits data acquired by the data acquisition unit 4 to the RemoteSite 2. Also, the data transmission unit 5, when recovered from fault of the line with the RemoteSite 2, transmits differential data stored by the local storage unit 6 in the Disk 16 to the RemoteSite 2.

If data transmission by the data transmission unit 5 fails, the local storage unit 6 stores the differential data in the Disk 16 of the MainSite 1. Furthermore, the local storage unit 6 stores the differential data, after having switched a generation on the basis of either one of a predetermined time period for example, on a day basis or on a week basis, and a predetermined data amount for example, on a gigabyte basis or on a 10-gigabyte basis.

The data reception unit 7 received data (differential data, total data, and the differential data stored by the local storage unit 6 in the Disk 16) transmitted by the data transmission unit 5.

The data storage unit 8 stores the differential data received by the data reception unit 7 in the Disk 26, after having switched the generation on the basis of either one of a predetermined time period for example, on a day basis or on a week basis, and a predetermined data amount for example, on a gigabyte basis or on a 10-gigabyte basis. The data storage unit 8 also stores total data received by the data reception unit 7 in the Disk 26, as a first generation (generation at the beginning). The data storage unit 8 further stores the differential data that has been received by the data reception unit 7 and that has been stored by the local storage unit 6 in the Disk 16, as the same generation as the generation which has been stored by the local storage unit 6.

After the generation has been switched by the data storage unit 8, the data merge unit 9 merges the data stored as the generation before switching, into the total data.

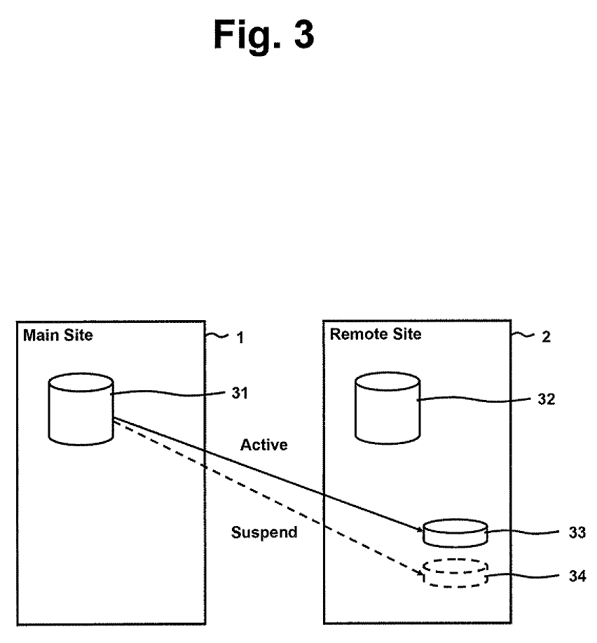

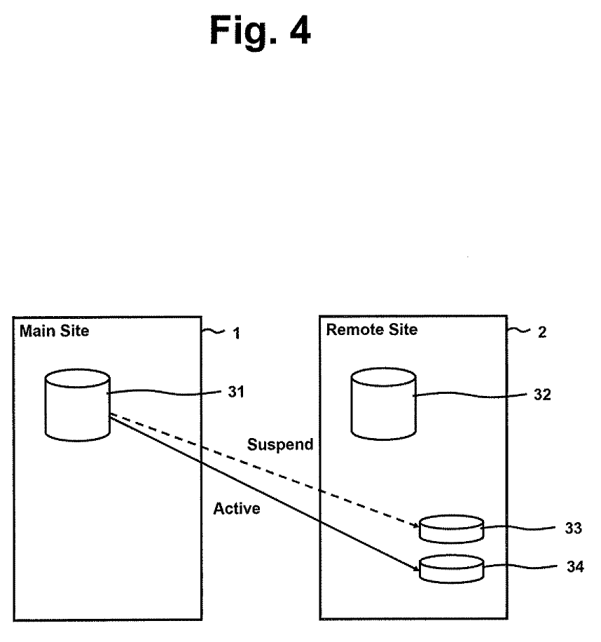

Now, backup proceeding in the present embodiment will be described with reference to FIGS. 3 and 4.

In general, it is not often that updating is performed with respect to an entire area within an extent (i.e., an extent designatable by defining it in advance with respect to operation data 31) within which backing-up is to be performed. In many case, only a portion within the extent is changed. Therefore, the storage system 3 reduces transfer amount and disk usage amount by the following processing. That is, as in the conventional art, regarding a first generation (data 32), full backup is performed by conducting mirroring by REC. On the other hand, regarding a second generation and later generations, full backup are not performed, and only a portion (data 33, 34) to be updated with respect to an immediately preceding generation is backed up by mirroring (refer to FIG. 3).

REC processing is performed in accordance with the following procedures. The data acquisition unit 4 in the MainSite 1 acquires all data within designatable extent out of operation data of the Disk 16; the data transmission unit 5 transmits the acquired total data to the data reception unit 7 in the RemoteSite 2; and the data storage unit 8 stores the data received by data reception unit 7 in the Disk 26. Thus, by performing full backup with respect to the designated extent, the REC processing is implemented. The REC processing is performed also when full backup from a predetermined generation in the MainSite 1 to the same generation in the RemoteSite 2 is conducted, besides when full backup for creating the first generation in the RemoteSite 2 is conducted.

For creating backup of update data alone, a REC such as to mirror the update data alone and not to transfer an unupdated portion, is used (hereinafter, such a REC is referred to as “SnapREC”. As needed, performing full backup is referred to as “REC” in order to clarify difference thereof from SnapREC). As shown in FIG. 4, when a predetermined time period or a predetermined data capacity (e.g., a time period or a data capacity that has been defined in advance) has been reached, and a current generation (e.g., the second generation 33 in FIG. 4) has been completed, the storage system 3 causes the current generation to enter a Suspend status (described later), and concurrently, starts SnapREC of a next generation, i.e., a third generation 34 in FIG. 4 (thereby the status enters Active as described later). Thus, the storage system 3 can go on collecting generation backup while maintaining an equivalent state.

SnapREC processing is performed in accordance with the following procedures. Every time data is updated from a predetermined point in time (out of operation data, a point in time when all data within designatable extent has been stored in the Disk 26 in the RemoteSite 2, or a point in time when a generation is switched by the data storage unit 8 in the RemoteSite 2), the data acquisition unit 4 acquires the differential data; the data transmission unit 5 transmits the acquired data (differential data) to the data reception unit 7 in the RemoteSite 2; and the data storage unit 8 stores the data received by the data reception unit 7 in the Disk 26. Thus, by backing up the differential data with respect to an operation volume from the predetermined point in time, the SnapREC processing is implemented.

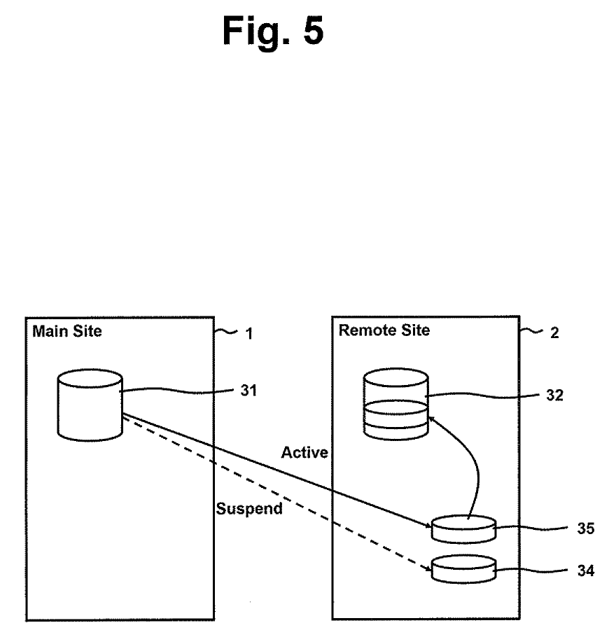

As shown in FIG. 5, while SnapREC with respect to a predetermined generation (e.g., the third generation 34 in FIG. 5) is being performed, the data merge unit 9 merges a generation immediately preceding the generation that is now being subjected to the backup processing, i.e., the second generation 33 in an example shown in FIG. 5, into full backup of the first generation 32, and upon completion of the merging, it deletes differential data of the generation 33 that has been merged.

Thereafter, upon completion of the SnapREC of the current generation (the third generation 34 in FIG. 5) by the data storage unit 8, the generation is switched and SnapREC of a fourth generation 35 is started with respect to a region in which the second generation 33 has been stored.

By repeating the foregoing processing, the storage system 3 can perform backup while maintaining an equivalence to a state of the operation volume (within the designated extent of the Disk 16 in the MainSite 1) that is being used by the user. Here, the storage system 3 is assumed to delete three stored generations in the order of generation from oldest to newest. However, the number of generations, or the order of deletion is not limited. For example, an operation such as not to treat a generation that we want to permanently retain, as a deletion target, is also conceivable.

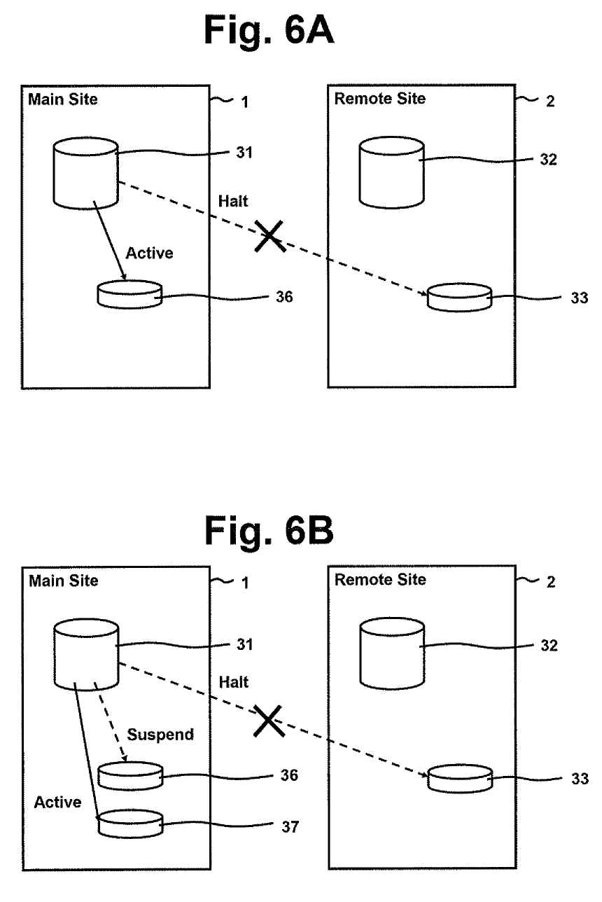

Next, processing in the case where a line fault or the like has occurred between the MainSite 1 and the RemoteSite 2 is described with reference to FIGS. 6A and 6B.

In data transfer from the MainSite 1 to the RemoteSite 2, there is a possibility that data transmission by the data transmission unit S may be interrupted due to the line fault or high load owing to frequent occurrences of I/Os. When the transmission is interrupted, the storage system 3 cannot create backup on the side of the RemoteSite 2 during a time period from a status in which data transmission is interrupted (i.e., Halt status) up to recovery. However, from the viewpoint of the recovery based on backup data, it is desirable to collect backup data over a plurality of generations at short time intervals, and the collection of backup needs to be continued even during Halt.

With such being the situation, as shown in “line fault state (during second generation mirroring)” in FIG. 6A, the local storage unit 6 creates temporary backup 35 in the MainSite 1 itself. That is, while a session status of the current SnapREC transits to Halt (“status” is described later), the local storage unit 6 performs mirroring of update data 36 alone (hereinafter, referred to as “SnapEC”) with respect to a local volume in the Disk 16 of the MainSite 1, whereby the storage system 3 can suppress disk capacity required for the continuation of backup and data transfer amount after line recovery, to a minimum.

The SnapEC processing refers to “processing in which the local storage unit 6 stores differential data 36 in the Disk 16 of the MainSite 1”.

As in the case of the above-described SnapREC, the SnapEC maintains an equivalent state by switching from a generation 36 to a generation 37 when a predetermined time period or a predetermined data capacity (e.g., a time period or data capacity that has been defined in advance) has been reached (refer to “generation backup acquisition” in FIG. 6B). Thus, a disk capacity that is to be prepared in the MainSite 1 becomes (update amount per generation)×(number of generations). In the present embodiment, the number of generations of backup of this SnapEC is assumed to be two (when full backup of the RemoteSite 2 is add, three), and deletion is assumed to be performed beginning at the oldest generation. However, as described above, the number of generations or the order of deletion is not limited.

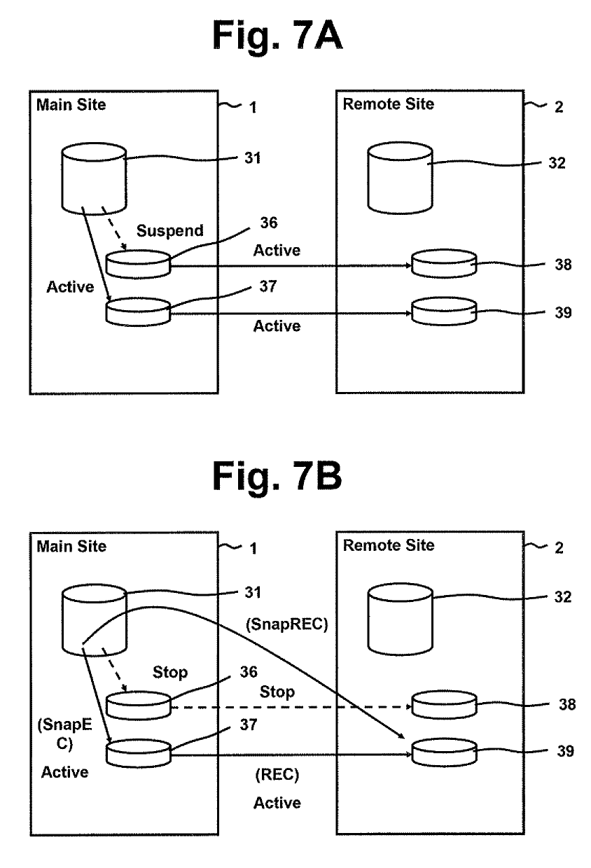

Now, processing at the time when the line between the MainSite 1 and the RemoteSite 2 has been recovered (i.e., processing after the path has been opened) is described with reference to FIGS. 7A and 7B. Here, the case where the line is recovered in the course of SnapEC of the third generation 37 after SnapEC has been completed up to the second generation 36, is taken as an example.

When the line between the MainSite 1 and the 2 has been recovered, regarding the second generation, backup by REC is performed from the second generation 36 of the MainSite 1, created by the SnapEC, to the second generation 36 of the RemoteSite 2. Regarding the third generation 37, 39, up until an equivalent state is reached, copy is performed by combination of SnapREC in FIG. 7B with respect to an operation volume and REC in FIG. 76; hereinafter referred to as “REC between differential data” as needed with respect to the third generation 37 in the MainSite 1.

The storage system 3 periodically performs copy by REC using a crawling engine (described later), and copies update data 36, 37 copied to a local volume in the MainSite 1 during Halt, to the RemoteSite 2. A unit 36, 37 updated during Halt, in the operation volume has been recorded in Bitmap corresponding to SnapEC in FIG. 7B. Here, Bitmaps are ones each representing uncopied/copied state by ON/OFF of Bit, and they are provided between individual volumes and placed under control). At the start of REC between differential data, the unit 36, 37 updated during Halt, in the operation volume, is merged into Bitmap corresponding to REC between differential data. As a result, REC, which is periodically performed, copies only a block that has been copied to the local volume of the MainSite 1, to the RemoteSite 2.

If update is performed with respect to the operation data before copy by the differential data REC is completed, Bit in the updated portion is turned OFF on the Bitmap of the REC between differential data, and thereupon, copy is performed to the RemoteSite 2 by SnapREC. This prevents copy by REC, which is periodically performed, from being subsequently performed to the pertinent portion.

By performing the above-described processing after the recovery of the line between the MainSite 1 and the RemoteSite 2, the volume states return to ordinary volume states in FIG. 5 before the transmission is interrupted.

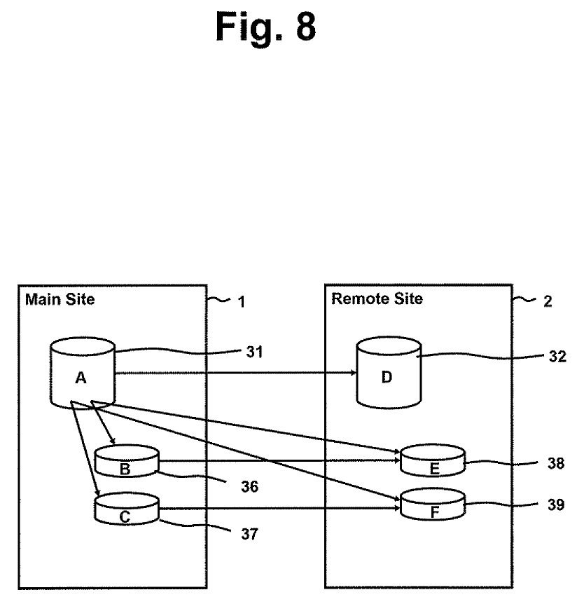

Next, statuses of sessions between the above-described volumes and their transitions are described. Hereinafter, the description is made on an assumption that the storage system 3 includes volume A to volume F as shown in FIG. 8. The volume A 31 is an operation volume that stores operation data being used in current operation in the MainSite 1, and the volumes B 36 and C 37 are volumes that hold differential data by SnapEC in the event that communications with the RemoteSite 2 is impossible due to occurrence of failure or the like. The volume D 32 in the RemoteSite 2 is a volume storing full backup data, and the volumes E 38 and F 39 are volumes that store differential data of the volume A 31 by SnapREC from a predetermined point in time.

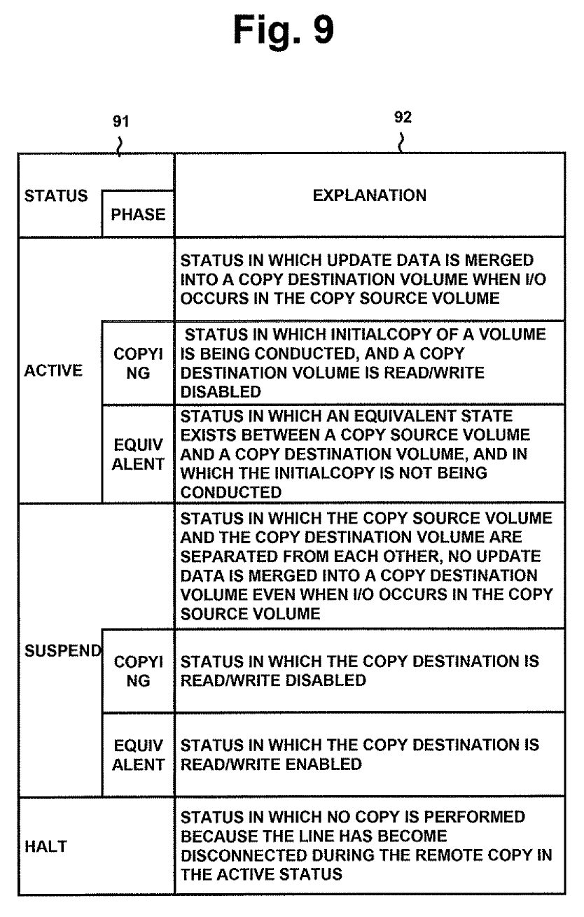

Now, statuses 91 of sessions between the volumes are explained with reference to FIG. 9 (statuses 91 correspond to explanations 92, respectively). The storage system 3 according to the present embodiment manages sessions between the volumes with the following three statuses: 1) a status in which update data is merged into a copy destination volume when I/O occurs in the copy source volume (Active status), 2) a status in which the copy source volume and the copy destination volume are separated from each other, so that no update data is merged into a copy destination volume even when I/O occurs in the copy source volume (Suspend status), and 3) a status in which no copy is performed because the line has become disconnected during the remote copy in the Active status (Halt status).

The Active status further includes two statuses: 1) a status in which total copy (hereinafter, InitialCopy) of a volume is being conducted, and a copy destination volume is Read/Write disabled (Copying status), and 2) a status in which an equivalent state exists between a copy source volume and a copy destination volume, and in which the InitialCopy is not being conducted (Equivalent status).

The Suspend status further includes two statuses: 1) a status in which the copy destination is Read/Write disabled (Copying status), and a status in which the copy destination is Read/Write enabled (Equivalent status).

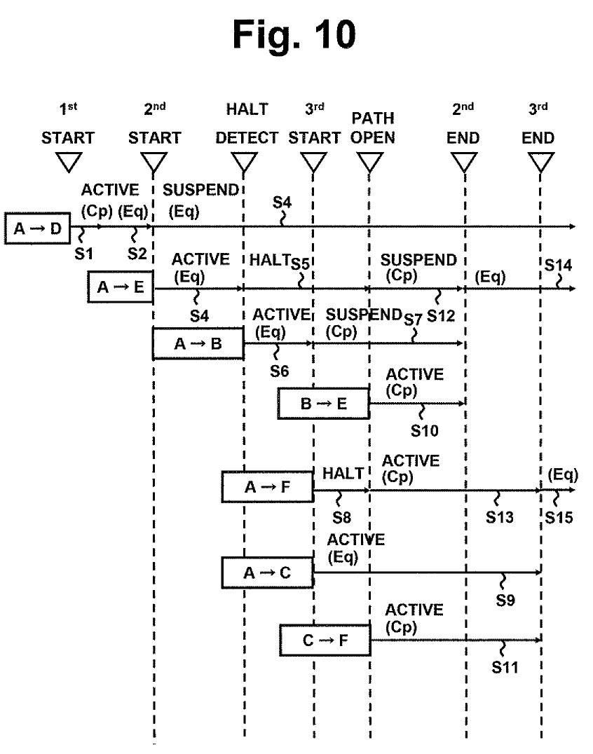

The above-described backup processing in the present embodiment is executed on the basis of session statuses. Here, transitions of the statuses in the above-described processings are described with reference to FIG. 10. In the descriptions below, for example, REC from the volume A to the volume D is expressed as REC (A to D), for example, SnapREC from the volume A to the volume E is expressed as SnapREC (A to E), and for example, SnapEC from the volume A to the volume B is expressed as SnapEC (A to B).

First, when REC (A to D) starts in order to create backup of the first generation (step S1), its session status becomes Active. Since the first generation is subjected to full backup, the status during InitialCopy immediately after the start is Copying. When the InitialCopy is completed and an equivalent state is reached, the status transits to Equivalent (step S2).

Next, when the second generation starts to be created, the first generation transits to Suspend, and the storage system 3 stops update between the volume A and the volume D (step S3). Simultaneously, the storage system 3 makes the status of session of the SnapREC (A to E) Active. Since the SnapREC (A to E) is not InitialCopy but copy of differential data, the status is Equivalent from the beginning (step S4).

If a line disconnection is detected while copying the second generation, the session with respect to the volume D all transits to Suspend (Copying), and stops merging of update data (refer to FIG. 5) by the data merge unit 9 (the transition of this status is not illustrated in FIG. 10). On the other hand, SnapREC (A to E) transits to Halt (step S5), and the storage system 3 makes SnapEC (A to B) Active in order to start difference copy to a local volume in the MainSite 1 (step S6). Here, in the storage system 3, because SnapEC is configured so that InitialCopy does not operate, its status becomes Equivalent.

When copy of the second generation has been completed and the SnapREC (A to F) with respect to the third generation is started, the SnapEC (A to B) transits to Suspend (Copying) and stops merging of update data (stop S7). Under normal conditions, the SnapREC (A to F) is concurrently started, but since the line is disconnected, its status becomes Halt (step S8). As a consequence, SnapEC (A to C) is started (step S9).

Thereafter, when the line between the MainSite 1 and the 2 is opened, the REC (B to E) and the REC (C to F), which merge data of a local volume in the MainSite 1 into the RemoteSite 2, are started (their statuses are each Active (Copying)) (steps S10 and S11).

The storage system 3 periodically checks volumes by the crawling engine, and if there is any copied update data in the volume B, the storage system 3 is to perform copy to the RemoteSite 2 by executing the REC (B to E) (above-described step S10). However, a copied during Halt has been recorded in the Bitmap of the SnapREC (A to B). Therefore, the REC (B to E) processing is performed in the following manner. Prior to starting copy of data, the Bitmap of the SnapEC (A to B) is merged into the Bitmap of the REC (B to E), and on the basis of the merged Bitmap, only a block that has been copied to the volume B is copied to the volume E. The same goes for REC (C to F) processing (the above-described step S11).

Thereafter, the status of session of the SnapREC (A to E) transits from Halt to Suspend (Copying) (step S12), and the SnapREC (A to F) is restarted by the status transiting from Halt to Active (step S13). Before the merging of local volume data is completed, an equivalent state is not reached, the status of the SnapREC (A to F) is Copying.

When copy to the second generation volume E has been completed, the SnapREC (A to E) transits to Suspend (Equivalent) (step S14), and Read/Write of the copy destination (volume E) becomes enabled. Here, the SnapEC (A to B) and the REC (B to E) stop sessions.

At the point in time when the copy to the second generation volume E has been completed, sessions with respect to the volume D all transit from Suspend (Copying) to Suspend (Equivalent), and enables the merging of update data (refer to FIG. 5) by the data merge unit 9 (the transfer of this status is not illustrated in FIG. 10).

When copy to the third generation volume F has been completed, the SnapREC (A to F) transits to Active (Equivalent) (step S15), and Read of the copy destination (volume F) becomes enabled. The SnapEC (A to C) and the REC (C to E) stop sessions.

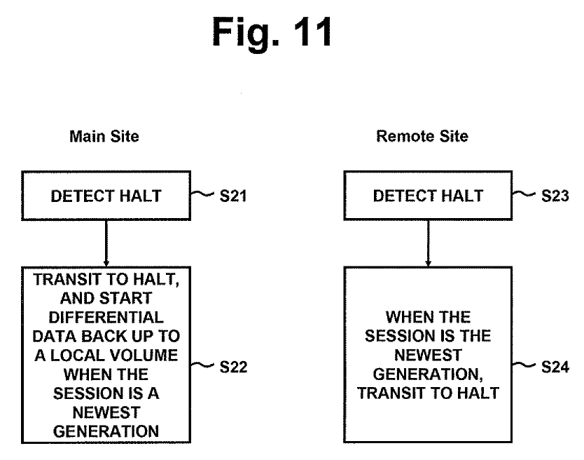

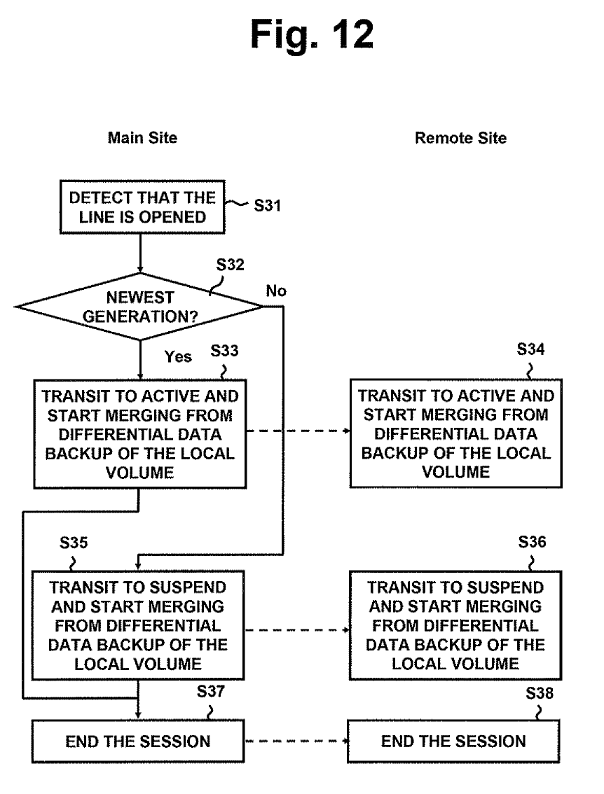

Now, description is made of processing with respect to the MainSite 1 and the RemoteSite 2 during line fault and line recovery (path opening), with reference to flowcharts in FIGS. 11 and 12. It is herein assumed that the storage system 3 performs processing in the flowcharts shown in FIGS. 11 and 12 for each session (for example, a session from the volume A to the volume E, and a session from the volume B to the volume E).

First, processing when the line fault has occurred is explained with reference to FIG. 11. When the MainSite 1 detects that the line is disconnected, and transmission fails (step S21), if the session is a newest generation (session in which copy is being performed), the MainSite 1 causes the status of the session to transit to Halt, and starts differential data back up to a local volume (Disk 16) inside the MainSite 1 (step S22).

When the RemoteSite 2 detects that the line is disconnected (step S23), if the session is the newest generation, the RemoteSite 2 causes the status of the session to transit to Halt (step S24).

Next, processing during path opening is described with reference to a flowchart in FIG. 12. When the MainSite 1 detects that the line is opened (step S31), it determines whether the session is the newest generation (step S32). If the session is the newest generation (step 32, Yes), the MainSite 1 (and the RemoteSite 2) cause(s) the status of the session to transit to Active, and start(s) merging from differential data backup of the local volume of the MainSite 1 (steps S33 and S34). Upon completion of the merging from the local volume of the MainSite 1, the MainSite 1 (and the RemoteSite 2) end(s) the session (steps S37 and S38).

On the other hand, if the session is not the newest generation (step S32, No), the MainSite 1 (and the RemoteSite 2) cause(s) the status of the session to transit to Suspend, and start(s) merging from differential data backup of a local volume of the MainSite 1 (steps S35 and S36).

After the path has opened, up until an equivalent state e.g., between the volume A and the volume F is reached, the storage system 3 must perform copy by combination of the REC (C to F) and the SnapREC (A to F). This processing is described below.

REC processing (as described above, REC processing is implemented by processings executed by the data acquisition unit 4, the data transmission unit 5, the data reception unit 7, and the data storage unit 8) is periodically performed, as the crawling engine. The REC processing is implemented by copying update data that has been copied to the volume C during Halt, to the volume F by the REC (C to F). The updated during Halt, in the operation volume has been recorded in Bitmap corresponding to the SnapEC (A to C), and is merged into the Bitmap corresponding to REC (C to F) when the REC (C to F) starts. Therefore, the crawling engine of REC (C to F) copies only the block that has been copied to the volume C, to the RemoteSite 2.

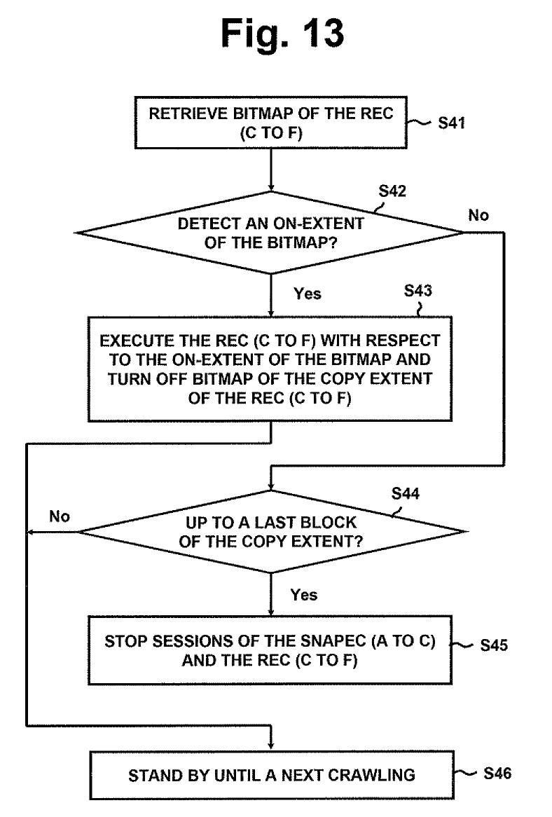

The foregoing content is further described with reference to a flowchart in FIG. 13. In FIG. 13, description is made as to how the REC processing is related to the SnapREC processing that is being performed all the time, in order that REC is periodically executed as the crawling engine. In the present processing, it is assumed that making generations correspond with each other (copy (REC processing) must be performed with respect to the identical generation) is performed by the data storage unit 8. Moreover, it is assumed that the following processing is executed by the crawling engine.

The crawling engine retrieves Bitmap of the REC (C to F) (step S41). If the crawling engine detects an ON-extent of the Bitmap (step S42, Yes), it further executes the REC (C to F) with respect to the ON-extent of the Bitmap, and turns OFF bitmap of the copy extent of the REC (C to F) (step S43).

Thereafter, the processing stands by until a next crawling (step S46).

In step S42, if the crawling engine does not detect the ON-extent of the Bitmap (step S42, No), it determines whether the retrieval has been performed up to a last block of the copy extent (step S44). When the retrieval has been performed up to the last block (step S44, Yes), the crawling engine stops sessions of the SnapEC (A to C) and the REC (C to F) (step S45). On the other hand, in step S44, when the retrieval has not been performed up to the last block (step S44, No), the processing stands by until a next start of the crawling engine (step S46).

If, before copy by the REC (C to F) is completed, update (Write processing) is performed with respect to the volume A, which is a volume of the copy source, Bit in the updated is turned OFF on the Bitmap of the REC (C to F), and thereupon, copy is performed to the RemoteSite 2 by the SnapREC (A to F). This prevents copy by the crawling engine from being subsequently performed to the pertinent.

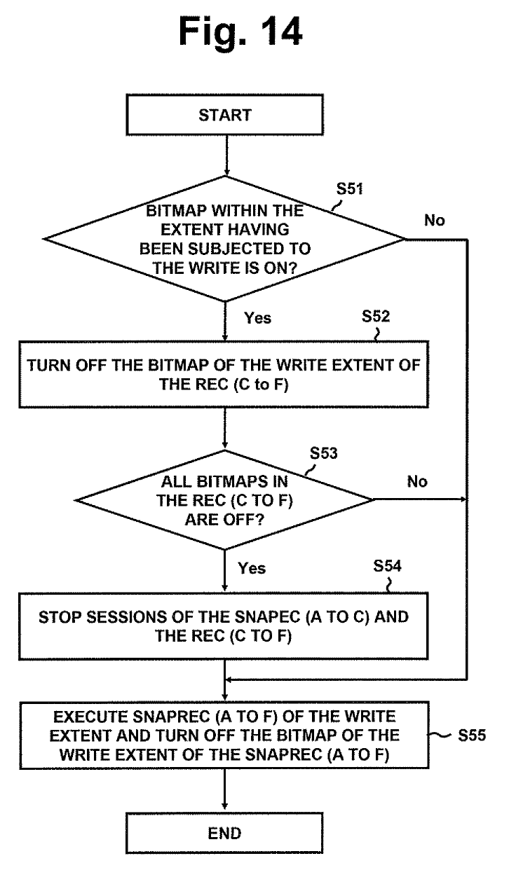

This processing is further described with reference to a flowchart in FIG. 14.

When Write processing is performed with respect to the volume A, the crawling engine checks whether the Bitmap within the extent having been subjected to the Write, in the REC (C to F) is ON (step S51). If this Bitmap is ON (step S51, Yes), the crawling engine turns OFF the Bitmap of the Write extent of the REC (C to F) (step S52).

If all Bitmaps in the REC (C to F) are OFF (step S53, Yes), the crawling engine stops sessions of the SnapEC (A to C) and the REC (C to F) (step S54), and executes SnapREC (A to F) of the Write extent as well as turns OFF the Bitmap of the Write extent of the SnapREC (A to F) (step S55).

If the Bitmap is not ON in step S51, and all Bitmaps are not OFF (step S53, No), the processing advances to S55.

In this manner, even under a situation in which transfer to the remote site is interrupted due to a line fault, collection of generation backup is possible.

The storage system 3 according to the present embodiment has two casings: the MainSite 1 and the RemoteSite 2. However, the storage system 3 may have a plurality of copy source casings and a plurality of copy destination casings. For example, from the viewpoint of load dispersion and the safety of backup, the storage system 3 may be configured to have a plurality of copy destination casings with respect to one copy source casing. Alternatively, the storage system 3 may be configured to have a plurality of copy destination casings with respect to a plurality of copy source casings.

The first storage unit corresponds to the Disk 16 in the present embodiment, and the differential data acquisition unit and the total data acquisition unit correspond to the data acquisition unit 4 in the present embodiment. Furthermore, the differential data transmission unit and the total data transmission unit correspond to the data transmission unit 5 in the present embodiment.

The second storage unit corresponds to the Disk 26 in the present embodiment, and the differential data reception unit and the total data reception unit correspond to the data reception unit 7 in the present embodiment. Furthermore, the differential data storage unit and the total data storage unit correspond to the data storage unit 8 in the present embodiment.

All examples and conditional language recited herein are intended for pedagogical purposes to aid the reader in understanding the invention and the concepts contributed by the inventor to furthering the art, and are to be construed as being without limitation to such specifically recited examples and condition, nor does the organization of such examples in the specification relate to a showing of superiority and inferiority of the invention. Although the embodiment of the present inventions have been described in detail, it should be understood that the various changes, substitutions, and alternations could be made hereto without departing from the spirit and scope of the invention.

What is claimed is:

1. A storage device for backing up data to an another storage device periodically comprising:
a storage unit for storing data;
a memory for storing management information indicative of locations of updated portion of the data;
a local storage unit for storing differential data as backup data;
a controller for controlling the storage device to back up data to the another storage device in accordance with a process comprising the steps of:
updating data stored in the storage unit;
updating management information corresponding to the updated portions of the data;
transmitting differential data to the another storage device, the differential data being the updated portions of the data which have been updated after preceding backing up of data until current backing up of data;
resetting the management information after transmitting the differential data;
storing, when the storage device fails transmission of the differential data to the another storage device, the differential data and the associated management information in the local storage unit; and
transmitting the differential data to the another storage device at a later time after resetting of the management information.

2. The storage device according to claim 1, wherein the controller transmits total data to the another storage device as a first generation in the data.

3. The storage device according to claim 2, wherein the another storage devices merges the differential data into the total data after the generation has been switched the another storage device.

4. The storage device according to claim 1, wherein the another storage device receives the differential data at the later time after resetting of the management information and stores the differential data as the same generation as the generation which has been stored by the local storage unit.

5. A data backup method for controlling a storage device to back up data to an another storage device periodically, the data backup method comprising the steps of:
updating data stored in a storage unit;
updating management information corresponding to the updated portions of the data;
transmitting differential data to the another storage device, the differential data being the updated portions of the data which have been updated after preceding backing up of data until current backing up of data;
resetting the management information after transmitting the differential data;
storing, when the storage device fails transmission of the differential data to the another storage device, the differential data and the associated management information in the local storage unit; and
transmitting the differential data to the another storage device at a later time after resetting of the management information.

6. The data backup method according to claim 5, further comprising the steps of;
transmitting total data to the another storage device as a first generation in the data.

7. The data backup method according to claim 6, further comprising the steps of:
merging the differential data into the total data after the generation has been switched the another storage device.

8. The data backup method according to claim 5, wherein the another storage device receives the differential data at the later time after resetting of the management information and stores the differential data as the same generation as the generation which has been stored by the local storage unit.
